(19) United States
(12) Patent Application Publication
(10) Pub. No.: US 2018/0109801 A1
(43) Pub. Date: Apr. 19, 2018

(54) Frame Output Method And Device

(71) Applicant: Shenzhen China Star Optoelectronics Technology Co., Ltd., Shenzhen, Guangdong (CN)

(72) Inventors: Wei FU, Shenzhen, Guangdong (CN); Yu WU, Shenzhen, Guangdong (CN)

(73) Assignee: Shenzhen China Star Optoelectronics Technology Co., Ltd., Shenzhen, Guangdong (CN)

(21) Appl. No.: 15/109,772

(22) PCT Filed: May 24, 2016
(86) PCT No.: PCT/CN2016/083075

§ 371 Date: Jul. 5, 2016

(30) Foreign Application Priority Data
Mar. 30, 2016 (CN) 201610192740.9

(51) Int. Cl. H04N 19/423; H04N 19/90; H04N 19/85; H04N 19/147; H04N 19/172; G09G 3/36

(52) U.S. Cl. CPC H04N 19/423; H04N 19/90; H04N 19/85; G09G 2340/02; H04N 19/172; G09G 3/36; H04N 19/147

(57) ABSTRACT

The present disclosure teaches a frame output method including the steps of: compressing a Nth frame into a compressed Nth frame using a compression method identical to that of compressing a (N−1)th frame into a compressed (N-1)th frame; storing the compressed Nth frame; decompressing the compressed Nth frame into a decompressed Nth frame using a decompression method identical to that of the decompressing the compressed (N−1)th frame into a decompressed (N−1)th frame; comparing the decompressed Nth frame and the decompressed (N−1)th frame and obtaining a comparison result; and providing an output frame according to the decompressed Nth frame and the comparison result. The present disclosure also teaches a frame output device. The frame output device and method described above are able to avoid the frame distortion problem resulted from Over Driver (OD) calculation, thereby enhancing image frame display quality.

### BACKGROUND OF THE INVENTION

### 1. Field of the Invention

The present invention relates to display technologies, and in particular to a frame output method and device.

### 2. The Related Arts

Currently when a liquid crystal display (LCD) switches frames, a newly displayed frame cannot reach desired grey levels in time due to the limitation of liquid crystal response speed, therefore leading to streaks and compromising the display quality. The LCD driver circuit as such usually employs an Over Driver (OD) method to twist liquid crystal molecules more rapidly so that a new frame may reach desired grey levels in time, the streaks are avoided, and frame dynamic display quality is enhanced.

In existing OD methods, a previous frame is stored first and then a current frame is compared against the previous frame. The current frame is then output after OD calculation. The memory for storage is sizable and costly, and the previous frame is often compressed before storage, and the compressed previous frame is decompressed before comparison. The current frame is compared against the decompressed previous frame and then output after OD calculation.

There is a problem in the above described OD methods. It is well known that compression usually leads to distortion. Even when the previous frame (before compression) and the current frame are identical, distortion is inevitable in the output current frame after OD calculation.

### SUMMARY OF THE INVENTION

To obviate the shortcoming of the prior art, an objective of the present disclosure is to provide a frame output method including the steps of: compressing a Nth frame into a compressed Nth frame using a compression method identical to that of compressing a (N−1)th frame into a compressed (N−1)th frame; storing the compressed Nth frame; decompressing the compressed Nth frame into a decompressed Nth frame using a decompression method identical to that of the decompressing the compressed (N−1)th frame into a decompressed (N−1)th frame; comparing the decompressed Nth frame and the decompressed (N−1)th frame and obtaining a comparison result; and providing an output frame according to the decompressed Nth frame and the comparison result.

Specifically, if the decompressed Nth frame contains data different from that of the decompressed (N−1)th frame, the method obtains a compensation data from a look up table of an internal over driver, and applies the compensation data to the decompressed Nth frame to obtain the output frame.

Specifically, the compensation data corresponds to the comparison result between the decompressed (N−1)th and decompressed Nth frames.

Specifically, if the decompressed Nth frame contains data identical to that of the decompressed (N−1)th frame, the method provides the decompressed Nth frame as the output frame.

Specifically, the frame output method is implemented in a controller of a liquid crystal display (LCD) device.

Another objective of the present disclosure is to provide a frame output device including: a compression module for compressing a Nth frame into a compressed Nth frame using a compression method identical to that of compressing a (N−1)th frame into a compressed (N−1)th frame; a storage module for storing the compressed Nth frame; a decompression module for decompressing the compressed Nth frame into a decompressed Nth frame using a decompression method identical to that of the decompressing the compressed (N−1)th frame into a decompressed (N−1)th frame; and a data comparison module for comparing the decompressed Nth frame against the decompressed (N−1)th frame to obtain a comparison result and providing an output frame according to the decompressed Nth frame and the comparison result.

Specifically, if the decompressed Nth frame contains data different from that of the decompressed (N−1)th frame, the data comparison module obtains a compensation data from a look up table of an internal over driver, and applies the compensation data to the decompressed Nth frame to obtain the output frame.

Specifically, the compensation data corresponds to the comparison result between the decompressed (N−1)th and decompressed Nth frames.

Specifically, if the decompressed Nth frame contains data identical to that of the decompressed (N−1)th frame, the data comparison module provides the decompressed Nth frame as the output frame.

Specifically, the frame output device is incorporated in a controller of a LCD device.

The frame output device and method taught by the present disclosure are able to avoid the frame distortion problem resulted from Over Driver (OD) calculation, thereby enhancing image frame display quality.

According to the present invention, the middle frame of the backlight module is designed to have separate strips. The back plate on the other hand provides locking mechanisms involving side walls and locking pieces so that the separate strips of the middle frame are slid into position along the back plate and reliably locked. There is no need to use bolts or other fastening means, reducing the difficulty in assembly/disassembly. The thinning of the backlight module and the display device therefor is effectively achieved.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a functional block diagram showing a frame output device according to an embodiment of the present disclosure; and

FIG. 2 is flow diagram showing a frame output method according to an embodiment of the present disclosure.

### DETAILED DESCRIPTION OF THE PREFERRED EMBODIMENTS

Embodiments of the present disclosure are described as follows with the accompanied drawings. However the embodiments are not intended to limit the scope, applicability or configuration of the disclosure in any way. Rather, the following description provides a convenient illustration for implementing exemplary embodiments of the disclosure. Various changes to the described embodiments may be made in the function and arrangement of the elements described without departing from the scope of the disclosure as set forth in the appended claims.

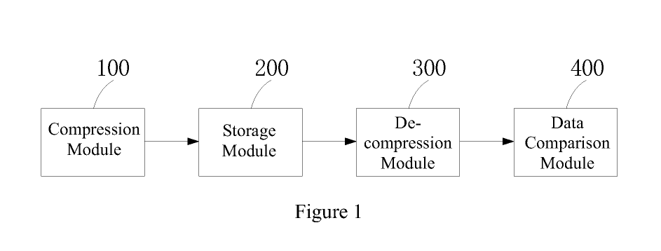

FIG. 1 is a functional block diagram showing a frame output device according to an embodiment of the present disclosure.

As illustrated, the frame output device includes a compression module 100, a storage module 200, a decompression module 300, and a data comparison module 400.

The frame output device receives an (N−1)th frame and an Nth frame from a circuit of a previous stage. The (N−1)th frame is earlier than the Nth frame where N is greater than or equal to 2 and N is a positive integer.

After the compression module 100 receives the (N−1)th frame, the compression module 100 compresses the (N−1)th frame into a compressed (N−1)th frame according to a compression method. The compressed (N−1)th frame contains a smaller amount of data than that of the (N−1)th frame.

As there is a time delay between the (N−1)th and Nth frames, and the operation of the compression and decompression modules 100 and 300 take time, the storage module 200 is provided to store the compressed frame for a period of time so that the time delay and processing time described above are compensated and the data comparison module 400 can process the (N−1)th and Nth frames smoothly.

The decompression module 300 decompresses the compressed (N−1)th frame into a decompressed (N−1)th frame according to a decompression method corresponding to the compression method in reverse. If the compression method is a lossless one, the decompressed (N−1)th frame should contain a same data as that of the (N−1)th frame.

Similarly, after the compression module 100 receives the Nth frame, the compression module 100 compresses the Nth frame into a compressed Nth frame according to the compression method. The compressed Nth frame contains a smaller amount of data than that of the Nth frame.

The storage module 200 stores the compressed Nth frame for the period of time.

The decompression module 300 decompresses the compressed Nth frame into a decompressed Nth frame according to the decompression method. If the compression method is a lossless one, the decompressed Nth frame should contain a same data as that of the Nth frame.

Finally, the data comparison module 400 compares the decompressed Nth frame against the decompressed (N−1)th frame and obtains a comparison result. The data comparison module 400 then provides an output frame according to the decompressed Nth frame and the comparison result.

Specifically, if the decompressed Nth frame contains a data different from that of the decompressed (N−1)th frame, the data comparison module 400 obtains a compensation data from a look up table of an internal over driver, and applies the compensation data to the decompressed Nth frame. The compensated Nth frame is then output. The compensation data corresponds to a data difference (i.e., the comparison result) between the decompressed (N−1)th and decompressed Nth frames.

If the decompressed Nth frame contains a same data as that of the decompressed (N−1)th frame, the data comparison module 400 directly outputs the decompressed Nth frame.

The frame output device can be incorporated in a controller (e.g., timing controller, TCON) of a liquid crystal display (LCD) device. However the present disclosure is not limited as such. The frame output device can also be independently configured in a LCD.

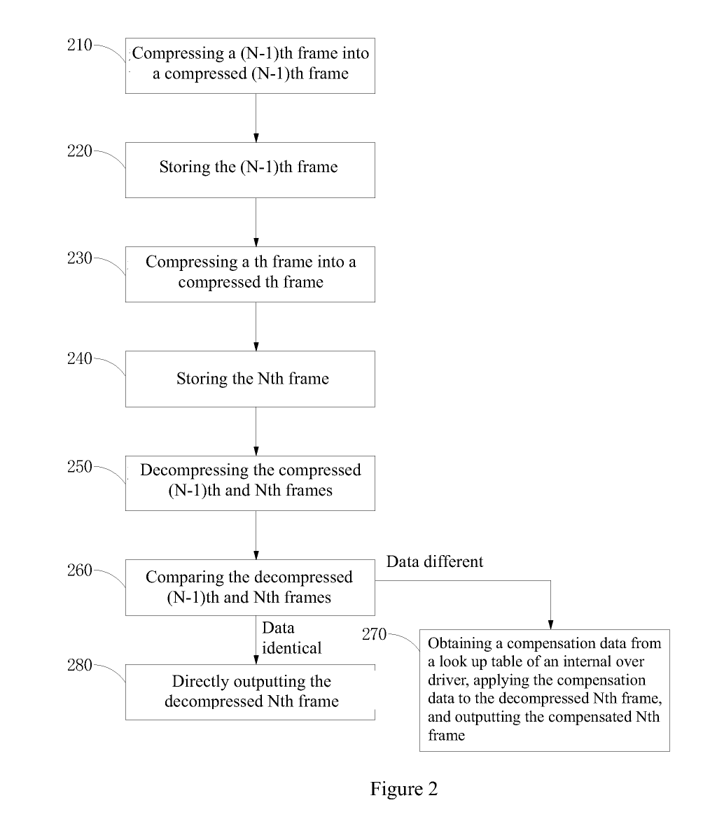

FIG. 2 is flow diagram showing a frame output method according to an embodiment of the present disclosure.

Referring to FIGS. 1 and 2, the frame output device of FIG. 1 follows the frame output method of FIG. 2 to output frames. The frame output method is as follows.

In step 210, after the compression module 100 receives the (N−1)th frame, the compression module 100 compresses the (N−1)th frame into the compressed (N−1)th frame according to a compression method. The compressed (N−1)th frame contains a smaller amount of data than that of the (N−1)th frame.

In step 220, the storage module 200 stores the compressed (N−1)th frame for a period of time.

In step 230, after the compression module 100 receives the Nth frame, the compression module 100 compresses the Nth frame into the compressed Nth frame according to the compression method. The compressed Nth frame contains a smaller amount of data than that of the Nth frame.

In step 240, the storage module 200 stores the compressed Nth frame for the period of time.

In step 250, the decompression module 300 decompresses the compressed (N−1)th frame and the compressed Nth frame into the decompressed (N−1)th frame and the decompressed Nth frame, respectively, according to the decompression method. The decompression method corresponds to the compression method in reverse. If the compression method is a lossless one, the decompressed (N−1)th and Nth frames should contain same data as those of the (N−1)th and Nth frames.

In step 260, the data comparison module 400 compares the decompressed Nth frame against the decompressed (N−1)th frame and obtains the comparison result. The data comparison module 400 then provides an output frame according to the decompressed Nth frame and the comparison result.

Specifically, if the decompressed Nth frame contains data different from that of the decompressed (N−1)th frame, the method goes to step 270. Otherwise, the method goes to step 280.

In step 270, the data comparison module 400 obtains the compensation data from the look up table of the internal over driver, and applies the compensation data to the decompressed Nth frame. The compensated Nth frame is then output. The compensation data corresponds to a data difference (i.e., the comparison result) between the decompressed (N−1)th and decompressed Nth frames.

In step 280, the data comparison module 400 directly outputs the decompressed Nth frame.

The frame output device and method described above are able to avoid the frame distortion problem resulted from Over Driver (OD) calculation, thereby enhancing image frame display quality.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A frame output method, comprising the steps of:
compressing a Nth frame into a compressed Nth frame using a compression method identical to that of compressing a (N−1)th frame into a compressed (N−1)th frame;
storing the compressed Nth frame;
decompressing the compressed Nth frame into a decompressed Nth frame using a decompression method identical to that of the decompressing the compressed (N−1)th frame into a decompressed (N−1)th frame;
comparing the decompressed Nth frame and the decompressed (N−1)th frame and obtaining a comparison result; and
providing an output frame according to the decompressed Nth frame and the comparison result.

2. The frame output method as claimed in claim 1, wherein, if the decompressed Nth frame contains data different from that of the decompressed (N−1)th frame, obtaining a compensation data from a look up table of an internal over driver, and applying the compensation data to the decompressed Nth frame to obtain the output frame.

3. The frame output method as claimed in claim 2, wherein the compensation data corresponds to the comparison result between the decompressed (N−1)th and decompressed Nth frames.

4. The frame output method as claimed in claim 1, wherein, if the decompressed Nth frame contains data identical to that of the decompressed (N−1)th frame, providing the decompressed Nth frame as the output frame.

5. The frame output method as claimed in claim 2, wherein, if the decompressed Nth frame contains data identical to that of the decompressed (N−1)th frame, providing the decompressed Nth frame as the output frame.

6. The frame output method as claimed in claim 3, wherein, if the decompressed Nth frame contains data identical to that of the decompressed (N−1)th frame, providing the decompressed Nth frame as the output frame.

7. The frame output method as claimed in claim 1, wherein the frame output method is implemented in a controller of a liquid crystal display (LCD) device.

8. A frame output device, comprising:
a compression module for compressing a Nth frame into a compressed Nth frame using a compression method identical to that of compressing a (N−1)th frame into a compressed (N−1)th frame;
a storage module for storing the compressed Nth frame;
a decompression module for decompressing the compressed Nth frame into a decompressed Nth frame using a decompression method identical to that of the decompressing the compressed (N−1)th frame into a decompressed (N−1)th frame; and
a data comparison module for comparing the decompressed Nth frame against the decompressed (N−1)th frame to obtain a comparison result and providing an output frame according to the decompressed Nth frame and the comparison result.

9. The frame output device as claimed in claim 8, wherein, if the decompressed Nth frame contains data different from that of the decompressed (N−1)th frame, the data comparison module obtains a compensation data from a look up table of an internal over driver, and applies the compensation data to the decompressed Nth frame to obtain the output frame.

10. The frame output device as claimed in claim 9, wherein the compensation data corresponds to the comparison result between the decompressed (N−1)th and decompressed Nth frames.

11. The frame output device as claimed in claim 8, wherein, if the decompressed Nth frame contains data identical to that of the decompressed (N−1)th frame, the data comparison module provides the decompressed Nth frame as the output frame.

12. The frame output device as claimed in claim 9, wherein, if the decompressed Nth frame contains data identical to that of the decompressed (N−1)th frame, the data comparison module provides the decompressed Nth frame as the output frame.

13. The frame output device as claimed in claim 10, wherein, if the decompressed Nth frame contains data identical to that of the decompressed (N−1)th frame, the data comparison module provides the decompressed Nth frame as the output frame.

14. The frame output device as claimed in claim 8, wherein the frame output device is incorporated in a controller of a LCD device.
